(19) United States
(12) Patent Application Publication
(10) Pub. No.: US 2026/0119177 A1
(43) Pub. Date: Apr. 30, 2026

(54) STATIC IDENTIFICATIONS IN OBJECT-BASED MEMORY ACCESS

(71) Applicant: Micron Technology, Inc., Boise, ID (US)

(72) Inventor: Steven Jeffrey Wallach, Dallas, TX (US)

(21) Appl. No.: 19/432,076

(22) Filed: Dec. 23, 2025

Related U.S. Application Data
(63) Continuation of application No. 17/693,240, filed on Mar. 11, 2022, now Pat. No. 12,511,124.
Application No. 17/693,240 is a continuation of application No. 16/028,840, filed on Jul. 6, 2018, now Pat. No. 11,275,587.
(60) Provisional application No. 62/665,936, filed on May 2, 2018.

(51) Int. Cl. G06F 9/30; G06F 9/34

(52) U.S. Cl. CPC G06F 9/30112; G06F 9/342

(57) ABSTRACT

A computer system having an address system of a first predetermined width in which each address of the first predetermined width in the address system includes a first portion identifying an object and a second portion identifying an offset relative to the object, where a static identifier for the first portion is predetermined to identify an address space having a second predetermined width that is smaller than the first predetermined width, or a space of kernel objects.

### RELATED APPLICATIONS

The present application is a continuation application of U.S. Pat. App. Ser. No. 17/693,240 filed March 11, 2022, issued as U.S. Pat. No. 12,511,124 on December 30, 2025, which is a continuation application of U.S. Pat. App. Ser. No. 16/028,840 filed July 6, 2018, issued as U.S. Pat. No. 11,275,587 on March 15, 2022 which claims the benefit of the filing date of Prov. U.S. Pat. App. Ser. No. 62/665,936, filed May 2, 2018 and entitled “Static Identifications in Object-based Memory Access,” the entire disclosure of which applications are hereby incorporated herein by reference.

The present application relates to U.S. Pat. App. Ser. No. 16/028,750, filed July 6, 2018 and issued as U.S. Pat. No. 10,761,855 on Sep. 1, 2020, which claims the benefit of the filing date of Prov. U.S. Pat. App. Ser. No. 62/665,743, filed May 2, 2018, the entire disclosures of which applications are hereby incorporated herein by reference.

### FIELD OF THE TECHNOLOGY

At least some embodiments disclosed herein relate generally to computer architecture and more specifically, but not limited to, memory addresses for computer processors.

### BACKGROUND

A memory address in a computing system identifies a memory location in the computing system. Memory addresses are fixed-length sequences of digits conventionally displayed and manipulated as unsigned integers. The length of the sequences of digits or bits can be considered the width of the memory addresses. Memory addresses can be used in certain structures of central processing units (CPUs), such as instruction pointers (or program counters) and memory address registers. The size or width of such structures of a CPU typically determines the length of memory addresses used in such a CPU.

### BRIEF DESCRIPTION OF THE DRAWINGS

The embodiments are illustrated by way of example and not limitation in the figures of the accompanying drawings in which like references indicate similar elements.

FIG. 1 shows a computer system using an address system according to one embodiment.

FIG. 2 shows static object identifications in an address system of FIG. 1.

FIGS. 3 and 4 illustrate the use of static object identifications to map addresses of different address spaces.

### DETAILED DESCRIPTION

The present disclosure includes the techniques of using static object identification numbers in addresses of a predetermined width (e.g., 128-bit) for an instruction set (e.g., 128-bit instructions) to represent certain types of objects, such as kernel objects, objects using addresses of a smaller width (e.g., 64-bit, 32-bit) that are generated and/or used by other instruction sets (e.g., 64-bit instructions, 32-bit instructions), etc. In general, the addresses of the predetermined width (e.g., 128-bit) can be generated using various instruction sets (e.g., 128-bit instructions, 64-bit instructions, 32-bit instructions) in various processors that can use such instruction sets to generate and/or use addresses of the predetermined width (e.g., 128-bit). Thus, the predetermined width (e.g., 128-bit) is not limited to a particular type of instruction sets and/or instructions of a particular width.

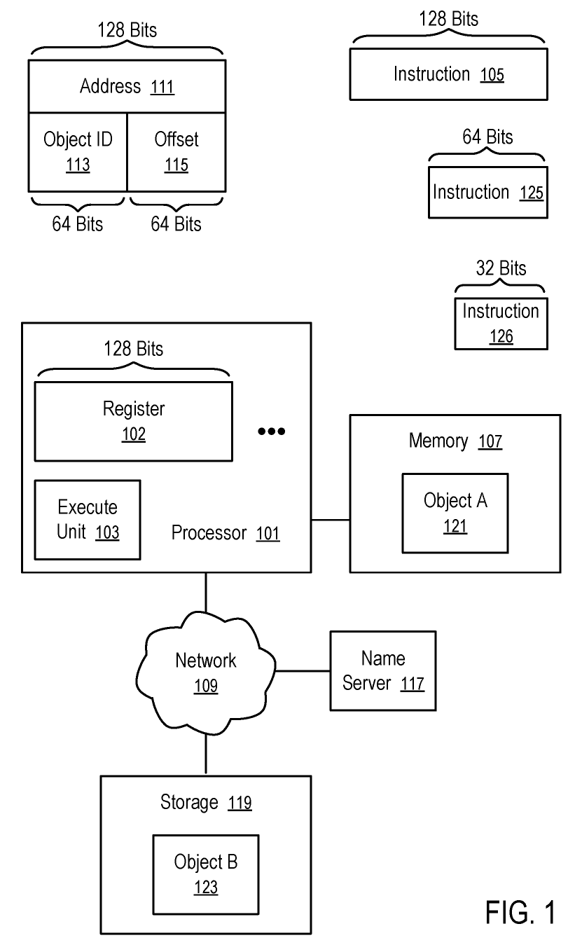

FIG. 1 shows a computer system using an address system according to one embodiment.

In FIG. 1, a processor (101) (e.g., a microprocessor or CPU) has an execution unit (103) to perform operations of instructions (e.g., 105) programmed according to one or more instruction sets that can generate 128-bit virtual memory addresses (e.g., 128-bit instruction set).

An example of the 128-bit instruction set is RV128 of RISC-V instruction set identified by the RISC-V Foundation.

The processor (101) is configured with registers (e.g., 102) of a predetermined width, such as 128 bits. The processor (101) can fetch an instruction (105) of the predetermined width, and use an execute unit (103) to perform operations on data provided in the instruction (105) and/or data provided in one or more registers (e.g., 102) identified in the instruction (105), and when applicable, store the result of the operations identified by the instruction (105) in a register identified in the instruction (105).

The registers (e.g., 102) can include a memory register of the predetermined width (e.g., 128 bits) and/or an instruction pointer (or program counter) of the predetermined width (e.g., 128 bits).

For example, an instruction can be coded according to the predetermined specification of an instruction set to perform integer computation (e.g., add, or, xor), to perform control transfer (e.g., jump, branch), to load data/instructions from memory at a memory location specified using an address (e.g., 111) of the predetermined width, or to store data at a memory location specified using an address (e.g., 111) of the predetermined width (e.g., 128 bits).

For example, the address (111) can be used to identify a memory location storing an instruction in the computer system; and the address (111) can be placed in an instruction pointer (or program counter) to identify the instruction to be executed by the processor (101).

For example, the address (111) can be used to identify a memory location storing a data item in the computer system; and the address (111) can be placed in a memory register to identify the data to be operated upon by the processor (101) in executing an instruction.

Typically, a 128-bit instruction set can address a 128-bit address space. Similarly, a 64-bit instruction set can address a 64-bit address space; and a 32-bit instruction set can address a 32-bit address space.

In some instances, a 64-bit instruction (e.g., 125) (or a 32-bit instruction (e.g., 126)) can also generate and/or use a 128-bit address (e.g., 111). For example, when a 128-bit address is stored in an address register (e.g., 102), the 64-bit instruction (125) (or a 32-bit instruction (126)) executed in the processor (101) (and/or another processor) can operate upon or use the 128-bit address (111) and/or generate another 128-bit address. Thus, the width of memory addresses is not necessarily limited by the width of instructions that generate or use the memory addresses.

In the computer system illustrated in FIG. 1, a 128-bit address (111) is configured to include two portions: a 64-bit object ID (113) and a 64-bit offset (115) relative to the object identified by the object ID (113). For example, the offset (115) can be a byte offset.

The 64-bit offset (115) can be used for indexing, such as program counter, stack pointer, for loading data and/or instruction from a memory location or for storing data at the location. The memory location can be in a main memory (107) connected to the processor (101) via one communication channel (e.g., a memory bus), or a storage (119) connected to the processor via another communication channel (e.g., over a network 109)

FIG. 1 illustrates an example structure for a 128-bit address. Other size choices can be implemented to have the structure of an object ID (113) and an offset (113) relative to the object identified by the object ID. For example, the width of the address can be different from 128 bits. For example, the object ID (113) and the offset (115) can be configured to have different numbers of bits.

In general, the 128-bit address system illustrated in FIG. 1 can be configured to be independent from instruction set architecture such that different vendors of different processors (e.g., 103) having different instruction sets can use the same address system. The memory access request made using the address (128) can be routed in a computer system over memory buses, input/output buses, and/or network (109) like routing internet protocol (IP) packets. Preferably, the association between a memory/storage location and the address (111) is persistent across time and space.

In response to an instruction (105, 125 or 126), the processor (101) can access a data item identified by the 128-bit memory address (111) stored in a register (102). The object ID (113) of the address (111) is usable to identify an object having a distinct name. Such an object can be a software or hardware structure with a name controlled, allocated, issued, and/or registered by a centralized name server (117). The name server (117) can be coupled to the processor (101) via a computer network (109); and the object (e.g., 121 or 123) represented by the object ID (113) can be in the memory (107) that is coupled to the processor (101) via a memory bus, or in a storage (119) that is coupled to the processor (101) via the network (109), or in memory coupled to another processor on the network (109).

An object identified by an object ID (113) in the address (111) can be used to specify location and protection mechanisms, language specific/architecture attributes, such as partitioned global address space (PGAS) node, data encrypted, and/or blockchain.

The object ID (113) of the corresponding object (121 or 123) can be created or allocated using the name server (117) for the entire computer system connected by the network (109), which can include the Internet.

Preferably, the address space using addresses (e.g., 111) in the format illustrated in FIG. 1 is unique over time and space. Any computer supporting the address space is addressable on the network (109) by the name server (117).

When a processor (101) is accessing an object for the first time, the access can require verification of permission to access (e.g., download an executable file, access an entry in an Access Control List (ACL)), and verification of access privileges for the object (e.g., read, write, execute, access through a protected sub-object, execution domain). Execution domain can be identified via classifications of the levels of users (e.g., gold, platinum, executive platinum) and admin level (e.g., 1, 2, …, n).

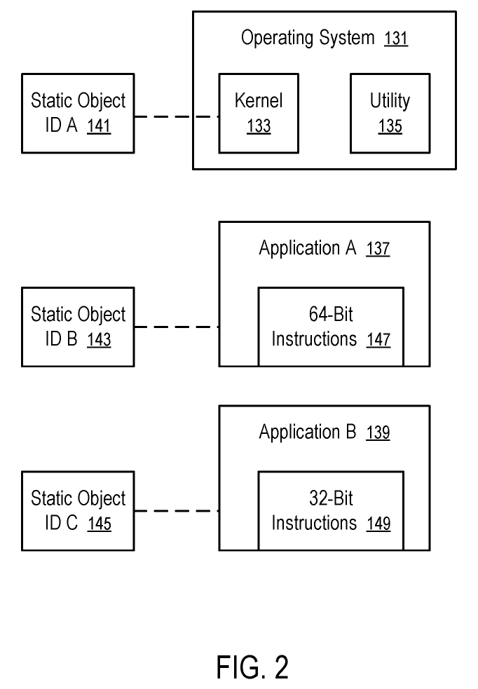

Certain static object IDs can be used to identify predetermined object types or object spaces, as illustrated in FIG. 2.

FIG. 2 shows static object identifications in an address system of FIG. 1.

For example, an object ID (141) having a predetermined value of zero (0) can be used to identify any kernel object (133) of an operating system (131); and the object ID (141) can be static for kernel objects (e.g., 133) across all the nodes in the computer system, regardless of the location of the kernel object (133) in the computer system. The operation system (131) can have utilities (e.g., 135) are not part of the kernel (133).

For example, an object ID (143) having a predetermined value of one (1) can be used to identify any object of an application (137) programmed using 64-bit instructions (143); and the object ID (143) can be static for 64-bit instruction objects (e.g., 137) across all the nodes in the computer system, regardless of the location of the 64-bit instruction object (137) in the computer system.

For example, an object ID (145) having a predetermined value of two (2) can be used to identify any object of an application (139) programmed using 32-bit instructions (147); and the object ID (145) can be static for 32-bit instruction objects (e.g., 139) across all the nodes in the computer system, regardless of the location of the 32-bit instruction object (139) in the computer system.

The static object IDs (141, 143, and/or 145) provide predetermined information about the objects accessed via the memory addresses (e.g., 111) having the static object IDs (141, 143, and/or 145).

For example, when the processor (101) accesses a memory location using the address (111) where the object ID (113) is the static object ID (141), the processor (101) can determine that the data or instruction stored in the memory location is for a kernel object (133) of an operating system (131). Thus, the processor (101) can adjust its operations (e.g., priority level, security level) based on the information that the accessed memory is for an operating system kernel (133).

Similarly, when the processor (101) accesses a memory location using the address (111) where the object ID (113) is the static object ID (143 or 145), the processor (101) can determine that the data or instruction stored in the memory location is for a 64-bit application (137) or a 32-bit application (139). Thus, the processor (101) can adjust its operations to optimize performances, priority and/or security for the application.

In general, static object IDs (e.g., 141, 143, and/or 145) can be used to provide the processor (101) with predetermined information about the objects referenced by the memory address (111) containing the static object IDs (e.g., 141, 143, and/or 145), without a need to contact the name server (117) to look up the property of the objects (e.g., 121 or 123). Thus, the computer system and/or the processor (101) can use the predetermined information in efficiently processing the data and/or instruction fetched using the address (111) that contains the static object IDs (e.g., 141, 143, or 145). For example, a static ID can be used to identify a partitioned global address space (PGAS) address of a predetermined width (e.g., 128-bit or 64 bit), a version of internet protocol addresses (e.g., Internet Protocol version 6 (IPv6)), a unique ID, etc. For example, a static ID can be used to indicate whether the object is a user object, a kernel object of an operating system (OS), or a non-kernel portion of an OS/server object. For example, a static ID can be used to indicate whether a system call is invoked, whether a call to the non-kernel portion of an OS/server is invoked, or whether a call to the kernel of an OS is invoked. In some instances, an address can have more than one static object ID encoded therein according to a predetermined scheme. For example, the static object IDs can be provided in an address without being limited to a particular 64-bit field of the address.

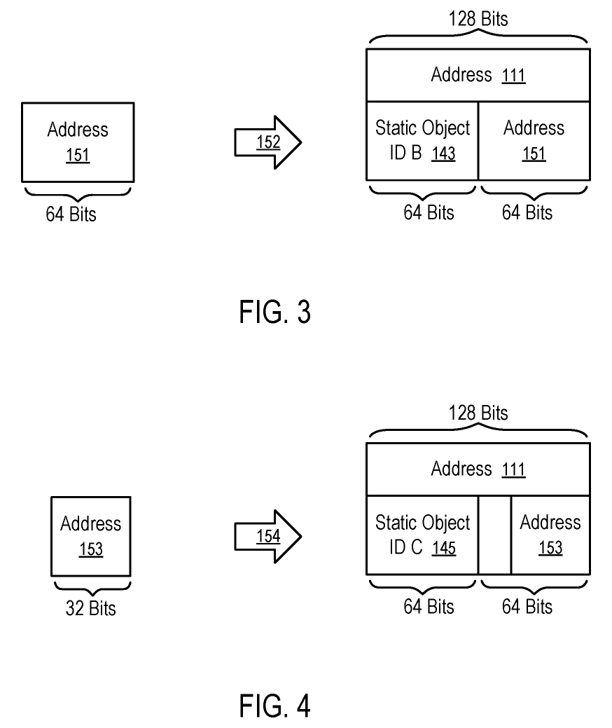

FIGS. 3 and 4 illustrate the use of static object identifications to map addresses of different address spaces.

Using the static object identifications (143 and 145), a computing system can automatically map the 64-bit address space and the 32-bit address space to the 128-bit address space according to predetermined rules. The conversion rule allows a 128-bit processor to run 64-bit applications and 32-bit applications.

For example, a 64-bit address (151) used by an application (137) programmed using 64-bit instructions (147) can be converted to a 128-bit address using the predetermined object ID (143) (e.g., a predetermined value of one (1)) for 64-bit objects, and using the 64-bit address (151) as the offset (115) in the 128-bit address (111), as illustrated in FIG. 3.

For example, a 32-bit address (153) used by an application (139) programmed using 32-bit instructions (149) can be converted to a 128-bit address using the predetermined object ID (145) (e.g., a predetermined value of two (2)) for 32-bit objects, and using the 32-bit address (153) as the offset (115) in the 128-bit address (111), as illustrated in FIG. 4.

The techniques disclosed herein can be applied to at least to computer systems where processors are separated from memory and processors communicate with memory and storage devices via communication buses and/or computer networks. Further, the techniques disclosed herein can be applied to computer systems in which processing capabilities are integrated within memory/storage. For example, the processing circuits, including executing units and/or registers of a typical processor, can be implemented within the integrated circuits and/or the integrated circuit packages of memory media to perform processing within a memory device. Thus, a processor (e.g., 101) as discussed above and illustrated in the drawings is not necessarily a central processing unit in the von Neumann architecture. The processor can be a unit integrated within memory to overcome the von Neumann bottleneck that limits computing performance as a result of a limit in throughput caused by latency in data moves between a central processing unit and memory configured separately according to the von Neumann architecture.

The description and drawings of the present disclosure are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A computer system, comprising:
a register, the register storing an address having:
a first portion identifying an object; and
a second portion identifying an offset relative to the object; and
an execution unit configured to load an instruction using the offset and execute the instruction using the address in accessing memory.

2. The computer system of claim 1, wherein the first portion comprises a static identifier pre-associated with a predetermined property of a class of objects used in executing the instruction.

3. The computer system of claim 2, wherein the class of objects comprises applications using an address space having a first predetermined width that is smaller than a second predetermined width of the address.

4. The computer system of claim 1, wherein the execution unit is further configured to load the instruction for execution using the address and is configured to operate on a data item obtained from a memory location identified by the address.

5. The computer system of claim 1, further comprising a name server coupled via a network and configured to allocate or register object identifiers, wherein the first portion identifies the object using an object identifier that is controlled, allocated, issued, or registered by the name server.

6. The computer system of claim 1, wherein the execution unit is further configured to load the instruction from a memory location identified by the address and to store a result of executing the instruction at a memory location identified by the address.

7. The computer system of claim 1, wherein the execution unit is further configured to verify permission to access the object identified by the first portion when accessing the object for a first time.

8. The computer system of claim 1, wherein the execution unit is further configured to verify access privileges for the object identified by the first portion, the access privileges comprising read, write, execute, access through a protected sub-object, or an execution domain.

9. The computer system of claim 1, wherein the execution unit is configured to adjust a security level during execution of the instruction based on a predetermined property associated with a static identifier in the first portion.

10. The computer system of claim 1, wherein the execution unit is configured to adjust a priority level during execution of the instruction based on a predetermined property pre-associated with a static identifier in the first portion.

11. The computer system of claim 1, wherein the execution unit is configured to execute the instruction using a static identifier without contacting a server to look up a property of the object identified by the first portion.

12. The computer system of claim 1, wherein the execution unit is configured to place the address in an instruction pointer to identify an instruction to be executed and to execute the identified instruction.

13. A method comprising:
storing, in a register of a processor, an address comprising a first portion that identifies an object and a second portion that identifies an offset relative to the object;
loading, by an execution unit of the processor, an instruction using the second portion;
executing, by the execution unit, the instruction using the address to access memory; and,
when the first portion comprises an identifier associated with a predetermined property of a class of objects, executing, by the execution unit, the instruction using the predetermined property.

14. The method of claim 13, further comprising executing the instruction using the predetermined property without performing a remote lookup of a property of the object identified by the first portion.

15. The method of claim 13, further comprising loading, by the execution unit, the instruction from a memory location identified by the address and storing, by the execution unit, a result of executing the instruction at the memory location identified by the address.

16. The method of claim 13, further comprising operating, by the execution unit, on a data item obtained from a memory location identified by the address.

17. The method of claim 13, further comprising placing, by the execution unit, the address in an instruction pointer to identify the instruction to be executed and executing, by the execution unit, the identified instruction.

18. The method of claim 13, further comprising routing, by the execution unit, a memory access request made using the address over a memory bus, an input/output bus, or a computer network to obtain data identified by the address.

19. The method of claim 13, further comprising further comprising indexing, by the execution unit, using the second portion as at least one of a program counter and a stack pointer.

20. A device comprising:
a memory; and
a processor, wherein the processor comprises:
a register configured to store an address, the address comprising a first portion that identifies an object and a second portion that identifies an offset relative to the object; and
an execution unit configured to load an instruction using the second portion and to execute the instruction using the address to access the integrated memory circuitry,
wherein, when the first portion comprises an identifier associated with a predetermined property, the execution unit executes the instruction without performing a remote lookup of a property of the object.
